(19) United States
(12) Patent Application Publication
(10) Pub. No.: US 2011/0033696 A1
(43) Pub. Date: Feb. 10, 2011

(54) RETROREFLECTIVE STICKERS AND FORMS

(75) Inventors: David J. Grubish, Maplewood, MN (US); Thanh-Huong T. Do, Oakdale, MN (US); Paul J. Northey, Somerset, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/537,065

(22) Filed: Aug. 6, 2009

(51) Int. Cl. B32B 5/00; B05D 3/00; B32B 37/00; B32B 38/00

(52) U.S. Cl. 428/334; 428/339; 427/385.5; 156/60; 156/280

(57) ABSTRACT

The present application generally relates to the formation of a microsphere-based laser-receptive retroreflective sheeting having a thickness of less than 0. 161 mm that exhibits reduced incidence of curling during and after printing. The reduced incidence of curling results from placement of an anticurl coating on at least a portion of the retroreflective sheeting. After curing, the anticurl coating includes a cross-linked acrylic acid resin. This resulting microsphere-based, laser-receptive retroreflective sheeting can, for example, be adhered or placed adjacent to a substrate to create a form.

### TECHNICAL FIELD

The present application relates to various methods of printing a form and/or a sticker and various forms and printable stickers.

### BACKGROUND

It is often desirable to supply a decal, sticker, or label to a recipient. In some instances, the decal, sticker, or label is releasably adhered to a form that is supplied (e.g., via mail or directly) to the recipient. The recipient removes the decal, sticker, or label from the form and applies it to an appropriate item, such as, for example, a membership card, a vehicle window, or a license plate.

The following background information is presented by way of example with reference to a form or printable substrate including one specific type of reflective or retroreflective decal, sticker, or label, but the application is meant to include all types of decals, stickers, and labels. One specific type of decal, sticker, or label is a validation sticker that may be used as proof of registration of automobiles and other motor vehicles (e.g., trucks, snowmobiles, etc.). The end user (e.g., vehicle owner) is typically mailed a printed form that includes a sheet of paper to which is releasably attached a sticker. The sticker portion of the form usually has variable information printed on its top surface, and the paper sheet portion of the form typically has variable information (e.g., the end user's name, and address, the amount paid, etc.) printed on its top surface. The stickers, which are typically reflective or retroreflective, generally have a printable top surface and an adhesive on the bottom surface. The top surface of the sticker and of the paper sheet may be, for example, digitally printed by an issuing agency. Upon receipt, the end user removes the printed sticker from the paper sheet and then contacts the exposed adhesive to the end user's automobile license plate in order to apply the sticker to the license plate.

Preferred methods of printing forms including a paper portion and a sticker portion differ from preferred methods of printing on paper largely because the printer and printing method must be capable of printing on the reflective or retroreflective sheeting of the sticker portion. Consequently, printers for and methods of printing stickers are often adapted to print forms. The printable top surface of the sticker and the printable surface of the paper substrate can be printed separately or simultaneously.

### SUMMARY

The inventors of the present application noticed that as the reflective or retroreflective sticker thickness decreases, the stickers attached to the form exiting the printer exhibits an increased incidence of sticker curling wherein the sticker spontaneously curls upward during progression of the form through the printer or following printing. Curling of a sticker on a form is undesirable because it hinders form stacking, which results in undesirable clumping of the printed forms in the stack of forms in the output tray of the printer. The resulting clumped forms are often rendered unacceptable for use or unusable. As the number of unusable forms increases, the manufacturing/printing cost per form increases, and thus the manufacturing efficiency undesirably decreases. These drawbacks are magnified in instances where the forms are printed in large batches, some of which include more than 1000 forms per batch. As batch size increases, the temperature of the printer typically increases, resulting in an increase in the incidence of sticker curling and in the number of unusable forms.

The inventors of the present application found that an anticurl coating can be applied to the sticker to render the sticker with desired flatness during and after printing. The application of this anticurl coating decreases or minimizes the incidence of sticker curling. Consequently, the anticurl coating reduces the number of unusable stickers on forms.

The present application relates to various methods of printing a sticker and various forms and printable stickers. The methods and printers described herein decrease or minimize the incidence of sticker curling during and after printing.

One embodiment of the present application relates to a form that includes a substrate; a release coating on at least a portion of the substrate; a printable, microsphere-based retroreflective sheeting adjacent to at least a portion of the release coating, the laser-receptive retroreflective sheeting having a first major surface and a second major surface and a thickness between the first and second major surfaces of less than about 0.161 mm; and a cross-linked acrylic acid resin anticurl coating on at least a portion of one of the first and second major surfaces of the laser-receptive retroreflective sheeting.

Another embodiment of the present application relates to a printable retroreflective sheeting includes a layer of microsphere-based retroreflective sheeting having a thickness of less than 0.161 mm; and a cross-linked acrylic acid resin anticurl coating on at least a portion of the laser-receptive retroreflective sheeting. This printable retroreflective sheeting can, for example, be adhered or placed adjacent to a substrate to create a form.

Another embodiment of the present application relates to a method of forming retroreflective sheeting that exhibits improved resistance to curling when printed including (1) providing a printable, microsphere-based retroreflective sheeting having a first major surface and a second major surface and a thickness between the first and second major surfaces of less than about 0.161 mm; and (2) coating at least a portion of one of the first and second major surfaces of the printable retroreflective sheeting with a cross-linkable acrylic acid resin coating and a cross-linking agent; and (3) curing the cross-linkable acrylic acid resin coating and a cross-linking agent to form a cross-linked acrylic acid resin coating. The method may, for example, further include coating at least a portion of the backside of the retroreflective sheeting with an adhesive; and adhering the retroreflective sheeting to a printable substrate.

### BRIEF DESCRIPTION OF DRAWINGS

FIG. 1 is a schematic view of one embodiment of a microsphere-based retroreflective sheet including an anticurl coating.

FIG. 2 is a schematic view of one embodiment of a form including the microsphere-based retroreflective sheet and anticurl coating of FIG. 1.

### DETAILED DESCRIPTION

As used herein, the term “form” is meant to refer to a construction including a sticker portion and a printable surface portion. In one or more embodiments, the printable surface portion may include, for example, paper, cotton, synthetic materials, plastics, and blends or combinations thereof. In some embodiments, the printable surface portion can be the same material as the sticker portion.

The term “sticker,” as used herein, relates to printable substrates having microsphere-based reflective or retroreflective properties, including, but not limited to, labels and decals that have a reflective or retroreflective surface which is receptive to printed indicia. In one or more of the embodiments, the sticker may include, for example, a retroreflective, reflective, plastic, porous, or non-porous material.

The present application generally relates to the formation of a microsphere-based printable (e.g., laser-receptive) retroreflective sheeting having a thickness of less than 0.161 mm that exhibits reduced incidence of curling during and after printing. In at least some embodiments, the microsphere-based, printable (e.g., laser-receptive) sheeting has a thickness that is between about 0.110 mm and about 0.155 mm. The reduced incidence of curling results from placement of an anticurl coating on at least a portion of the retroreflective sheeting. After curing, the anticurl coating includes a cross-linked acrylic acid resin. This resulting microsphere-based, printable (e.g., laser-receptive) retroreflective sheeting can, for example, be adhered or placed adjacent to a substrate to create a form.

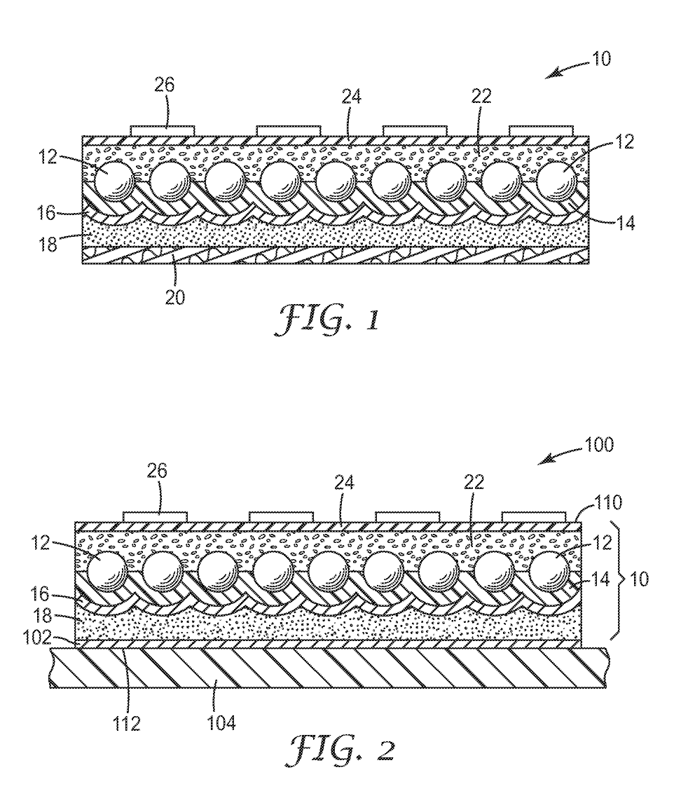

FIG. 1 is a schematic drawing showing an exemplary microsphere-based printable retroreflective sheeting 10 including a layer of glass microspheres 12 partially embedded in a binder layer 14. A retroreflective layer 16 (e.g., vapor deposited aluminum) is between binder layer 14 and an adhesive layer 18 (e.g., pressure sensitive adhesive layer). A release liner 20 may be positioned over adhesive layer 18 to protect the adhesive until the document is positioned for use. A layer 24 of an anticurl coating is positioned above a polymeric top film 22. Indicia 26 are printed on surface 24.

Many changes may be made to the embodiment shown in FIG. 1 without departing from the scope of the present application. For example, FIG. 1 shows a monolayer of glass microspheres 12, but those of skill in the art will understand that there can be multiple layers and/or that a single layer can include overlapping glass microspheres.

In one or more embodiments, microsphere-based retroreflective sheeting can include, for example, T7510 series sheeting sold by 3M Co.

In one or more embodiments, binder layer 14 can include, for example, polymeric resin. Exemplary commercially available binder layer materials include, for example, acrylics, urethanes, polyesters, or vinyls. In one or more embodiments, adhesive layer 18 can include, for example, a pressure sensitive adhesive, an acrylic adhesive, or rubber-based adhesive.

In one or more embodiments, release liner 20 may include, for example, a silicone release liner. In one or more embodiments, the print media used to form indicia 26 may be, for example, an ink or toner and may be colored or clear. One exemplary preferred print media is black in color. In one or more embodiments, the printer may be, for example, a laser printer.

Anticurl coating 24 includes a cross-linked or cross-linkable acrylic acid resin. A preferred commercially available anticurl coating is 3N-226 UV Plastic Gloss sold by Standard Register Co. and described in U.S. Pat. Nos. 6,416,911 and 6,376,135.

One preferred implementation of the anticurl coating includes an aqueous based dispersion or emulsion of a crosslinkable acrylic acid resin. An exemplary formulation includes between about 50 wt % and about 70 wt % acrylic acid resin (e.g., Carboset™ 2136 sold by B. F. Goodrich); between about 2 wt % and about 5 wt % crosslinking agent (e.g., zinc oxide, diethanolamine, and diethylenetriamine), and water. Anticurl coating 24 can also optionally contain between less than about 2 wt % of a surfactant (e.g., SWS 213 sold by Wacker Silicones Corp). In this embodiment, the coating is preferably cured by the application of heat to dry and crosslink the acrylate resin. The final coating is preferably transparent to visible light and does not substantially interfere with the retroreflective properties of the document.

In another embodiment, the anticurl coating includes between about 50 wt % and about 98 wt % of an acrylic acid ester monomer or oligomer having ethylenic saturation in its backbone (e.g., tripropylene glycol diacrylate, tripropylene glycol triacrylate, and hexanediol diacrylate); between about 2 wt % and about 8 wt % of a photocatalyst (Irgacure™ 651 sold by Ciba Geigy Corp.); and between about 0.5 wt % and about 2 wt % of a surfactant (e.g., a fluorocarbon-based composition such as, for example, FC-430 sold by 3M Corp.). Preferably, the acrylate monomers and oligomers having ethylenic unsaturation in their backbones also include one or more of the following functional groups: halogen, carboxylic acid, chlorinated rubber, or other polar functional group. Exemplary formulations for this embodiment include, but are not limited to:

Formulation 1: Rubber-modified acrylic 58.96 wt % 1,6 hexanediol acrylate 23.58 tripropylene glycol diacrylate 11. 79 photocatalyst 4.70 surfactant 0.94

Formulation 2 polyester acrylate 49.43 wt % 1,6 hexanediol acrylate 14.10 trimethylol tripropylene 28.24 triacrylate photocatalyst 7.56 surfactant 1.12

Formulation 3 tripropylene glycol diacrylate 14.80 wt % aromatic hydrocarbon resin 12.60 epoxy diacrylate 26.60 urethane acrylate 9.60 rubber modified acrylate 3.20 triacrylate 25.50 photocatalyst 7.20 surfactant 0.50.

In this embodiment, anticurl coating is preferably cured by exposure to ultraviolet radiation at wavelengths of from about 200 nm to about 400 nm. Alternatively, the anticurl coating may be cured by exposure to an electron beam.

Anticurl coating 24 may be applied using, for example, conventional printing or coating techniques. One exemplary example is the application of the anticurl coating at a rotary flexographic flood coating station of a conventional web fed, pressure-sensitive label converting press. Alternatively, the anticurl coating may be applied by gravure, screen printing, flood coating, anilox roll, or Meyer rod coating techniques or may be pattern coated or printed onto the retroreflective sheeting.

In at least some embodiments, the anticurl coating is applied in-line with other press printing and substrate converting procedures in the production of retroreflective documents such as labels, tags, and stickers. Alternatively, the anticurl coating may be applied as the final step in the manufacture of the retroreflective sheeting. Manufacturing techniques for retroreflective materials are well known and described, for example, in U.S. Pat. Nos. 4,268,117; 4,664,966; and 4,808,471.

In at least some embodiments, formation of the retroreflective sheeting of the present application involves providing a printable, microsphere-based retroreflective sheeting having a first major surface and a second major surface and a thickness between the first and second major surfaces of less than about 0.161 mm; coating at least a portion of one of the first and second major surfaces with a printable retroreflective sheeting with a cross-linkable acrylic acid resin coating and a cross-linking agent; and curing the cross-linkable acrylic acid resin coating and the cross-linking agent to form a cross-linked acrylic acid resin coating.

In at least some embodiments, the retroreflective material shown in FIG. 1 can be positioned adjacent to or onto a substrate to create a form. One exemplary embodiment of such a form is shown in FIG. 2, which is a schematic drawing of a form 100 including the retroreflective material 10 of FIG. 1. As shown in FIG. 2, retroreflective sheeting 10 is adhered (preferably releasably adhered) to substrate 104 by adhesive 102. Specifically, retroreflective sheeting 10 includes a first major surface 110 and a second major surface 112. Second major surface 112 is positioned adjacent to substrate 104. Exemplary substrates for use in form 100 include, for example, paper, cotton, synthetic materials, plastics, and blends or combinations thereof. Exemplary adhesives for use in form 100 include, for example, pressure sensitive adhesives such as acrylic-based and rubber-based adhesives.

The form shown in FIG. 2 can be manufactured by a variety of processes. One exemplary process involves providing a printable, microsphere-based retroreflective sheeting having a first major surface and a second major surface and a thickness between the first and second major surfaces of less than about 0.161 mm; coating at least a portion of one of the first and second major surfaces with a printable, retroreflective sheeting with a cross-linkable acrylic acid resin coating and a cross-linking agent; curing the cross-linkable acrylic acid resin coating and the cross-linking agent to form a cross-linked acrylic acid resin coating; adhering the second major surface of the retroreflective sheeting to a printable substrate.

The following examples describe some exemplary constructions of various embodiments of the retroreflective sheetings, forms, and methods of making the retroreflective sheeting and forms described in the present application. The following examples are intended to be illustrative, but are not intended to limit the scope of the present application.

### COMPARATIVE EXAMPLE A

Sixty “LV9000” sold by 3M Co. validation forms each including a sheet of paper to which were adhered two “rectangular retroreflective validation stickers. The stickers measured 2.54 cm by 3.81 cm and placed approximately ¼ inch (0.635 cm) apart was prepared. Indicia (letters and numbers) were printed across each validation form such that indicia were printed on each of the retroreflective validation stickers and onto the paper using a monochrome laser printer (available from Samsung, Seoul, Korea, under the trade designation “3561”).

The thickness of each retroreflective sticker with release liner and thickness of the release liner were measured as described in ASTM D3652/D3652 M-01. The thickness of the retroreflective sticker alone (i.e., without the release liner) was calculated by subtracting the thickness of the release liner from the thickness of the retroreflective sticker with the release liner applied thereto. The results are shown in Table 1.

### COMPARATIVE EXAMPLE B

Sixty separate LV9000 forms validation forms were prepared as described in Comparative Example A except that each sticker was replaced with a “T 7510” (sold by 3M Co.) rectangular retroreflective validation sticker. Indicia (letters and numbers) were printed across the validation form such that indicia were printed on each of the retroreflective validation stickers and onto the paper using a monochrome laser printer (available from Samsung, Seoul, Korea, under the trade designation “3561”).

The thickness of each retroreflective sticker with release liner and thickness of the release liner were measured as described in ASTM D3652/D3652 M-01. The thickness of the retroreflective sticker alone (i. e., without the release liner) was calculated by subtracting the thickness of the release liner from the thickness of the retroreflective sticker with the release liner applied thereto. The results are shown in Table 1.

### EXAMPLE 1

Sixty validation forms as described in Comparative Example B were prepared except that the retroreflective validation stickers had been coated with “3N-226 UV Plastic Gloss” anticurl coating (available from The Standard Register Company) before being adhered to the form. Specifically, a 12 in (30.5 cm) wide roll of microsphere-based validation retroreflective sheeting “T7510” sold by 3M Co. was coated with the UV curable coating in a flexographic flood coating station of a conventional web feed. The coating was subsequently cured using ultraviolet radiation. Indicia (letters and numbers) were printed across the validation form such that indicia were printed on each of the retroreflective validation stickers and onto the paper using a monochrome laser printer (available from Samsung, Seoul, Korea, under the trade designation “3561”).

The thickness of each retroreflective sticker with release liner and thickness of the release liner were measured as described in ASTM D3652/D3652 M-01. The thickness of the retroreflective sticker alone (i. e., without the release liner) was calculated by subtracting the thickness of the release liner from the thickness of the retroreflective sticker with the release liner applied thereto. The results are shown in Table 1.

TABLE 1
Comp. Example A, B, and Example 1 Sticker Thicknesses

| | | Calculated thickness of |
|---|---|---|
| | | the retroreflective |
| Example | Sample | sticker (mm) |
| Comparative | 1 | 0.167 |
| Example A | 2 | 0.161 |
| | 3 | 0.177 |
| | 4 | 0.166 |
| | 5 | 0.169 |
| Comparative | 1 | 0.110 |
| Example B | 2 | 0.108 |
| | 3 | 0.114 |
| | 4 | 0.116 |
| | 5 | 0.115 |
| Example 1 | 1 | 0.122 |
| | 2 | 0.117 |
| | 3 | 0.121 |
| | 4 | 0.119 |
| | 5 | 0.116 |

Printing tests for Comparative Example A, Comparative Example B, and Example 1 were run simultaneously as follows. Samples of Comparative Example A forms, Comparative Example B forms, and Example 1 forms were tested 24 hours, 48 hours, and 144 hours after preparation of the respective validation forms, as is described below:

Test Day 1: 24 hours after preparation of the forms described in Comparative Example A, Comparative Example B, and Example 1, 110 validation forms were placed in the printing tray and printed in the following order: 50 blank sheets of paper (i.e., sheets without reflective validation stickers adhered thereto), followed by 20 validation forms of Comparative Example A, 20 validation forms of Comparative Example B, and 20 validation forms of Example 1.

Test Day 2: 48 hours after preparation of the forms described in Comparative Example A, Comparative Example B, and Example 1, 50 blank sheets of paper (i.e., sheets without reflective validation stickers adhered thereto) and 20 validation forms from each of Comparative Example A, Comparative Example B, and Example 1 were randomly stacked, placed in the printing tray, and printed thereon.

Test Day 6: 144 hours after preparation of the forms described in Comparative Example A, Comparative Example B, and Example 1, 50 blank sheets of paper (i.e., sheets without reflective validation stickers adhered thereto) and 20 validation forms from each of Comparative Example A, Comparative Example B, and Example 1 were randomly stacked, placed in the printing tray, and printed thereon.

The printed samples were visually inspected and the results are shown in Table 2, where N is the number of samples for which at least a portion of at least one retroreflective sticker was found to be peeling off/curling from the form after printing.

TABLE 2
Summary of Printing Test Results

| Example | Test day | N |
|---|---|---|
| Comp. Ex. A | 1 | 1 |
| | 2 | 2 |
| | 6 | 0 |
| Comp. Ex. B | 1 | 10 |
| | 2 | 6 |
| | 6 | 0 |
| Example 1 | 1 | 0 |
| | 2 | 0 |
| | 6 | 0 |

A comparison of the data in Table 2 relating to Comparative Example A and B shows that relatively thick retroreflective materials (the average thickness of the materials used in Comparative Example A was 0.168 mm) exhibit low incidence of sticker curling while thinner retroreflective materials (the average thickness of the materials used in Comparative Example B was 0.112 mm) exhibit increased incidence of sticker curling. A comparison of the data in Table 2 relating to Comparative Example B and Example 1 shows that the addition of the anticurl coating to thinner retroreflective materials minimizes or eliminates the incidence of sticker curling.

Various modifications and alterations of the present disclosure will become apparent to those skilled in the art without departing from the spirit and scope of the disclosure. The scope of the present disclosure should, therefore, be determined only by the following claims.

What is claimed is:

1. A form, comprising:
a substrate;
a release coating on at least a portion of the substrate;
a printable, microsphere-based retroreflective sheeting adjacent to at least a portion of the release coating, the laser-receptive retroreflective sheeting having a first major surface and a second major surface and a thickness between the first major surface and the second major surface of less than about 0.161 mm; and
a cross-linked acrylic acid resin anticurl coating on at least a portion of the printable retroreflective sheeting.

2. The form of claim 1, wherein the substrate is selected from a group consisting essentially of paper, cotton, synthetic materials, plastics, and blends or combinations thereof.

3. The form of claim 1, wherein the release coating includes silicone.

4. The form of claim 1, further including a print media on at least one of the substrate and the printable, microsphere-based retroreflective sheeting.

5. The form of claim 1, wherein the printable, microsphere-based retroreflective sheeting has a thickness that is between about 0.110 mm and about 0.155 mm.

6. The form of claim 1, wherein the cross-linked acrylic acid resin coating includes an aqueous based dispersion or emulsion of a crosslinkable acrylic acid resin.

7. The form of claim 6, wherein the crosslinkable acrylic acid resin includes between about 50 wt % and about 70 wt % acrylic acid resin, between about 2 wt % and about 5 wt % crosslinking agent, and water.

8. The form of claim 7, wherein the crosslinkable acrylic acid resin further includes less than about 2 wt % of a surfactant.

9. The form of claim 6, wherein the crosslinkable acrylic acid resin includes between about 50 wt % and about 98 wt % of an acrylic acid ester monomer or oligomer having ethylenic saturation in its backbone, between about 2 wt % and about 8 wt % of a photocatalyst, and between about 0.5 wt % and about 2 wt % of a surfactant.

10. A printable retroreflective sheeting, comprising:
a layer of microsphere-based retroreflective sheeting having a thickness of less than 0.161 mm; and
a cross-linked acrylic acid resin anticurl coating on at least a portion of the printable retroreflective sheeting.

11. The printable retroreflective sheeting of claim 10, further including a layer of print media on the microsphere-based retroreflective sheeting.

12. The printable retroreflective sheeting of claim 10, wherein the microsphere-based retroreflective sheeting has a thickness that is between about 0.110 mm and about 0.155 mm.

13. The printable retroreflective sheeting of claim 10, wherein the cross-linked acrylic acid resin anticurl coating includes an aqueous based dispersion or emulsion of a crosslinkable acrylic acid resin.

14. The printable retroreflective sheeting of claim 13, wherein the crosslinkable acrylic acid resin includes between about 50 wt % and about 70 wt % acrylic acid resin, between about 2 wt % and about 5 wt % crosslinking agent, and water.

15. The printable retroreflective sheeting of claim 14, wherein the crosslinkable acrylic acid resin further includes less than about 2 wt % of a surfactant.

16. The printable retroreflective sheeting of claim 13, wherein the crosslinkable acrylic acid resin includes between about 50 wt % and about 98 wt % of an acrylic acid ester monomer or oligomer having ethylenic saturation in its backbone, between about 2 wt % and about 8 wt % of a photocatalyst, and between about 0.5 wt % and about 2 wt % of a surfactant

17. The printable retroreflective sheeting of claim 10, releasably adhered to a substrate.

18. A method of forming retroreflective sheeting that exhibits improved resistance to curling when printed, comprising:
providing a printable, microsphere-based retroreflective sheeting having a first major surface and a second major surface and a thickness between the first and second major surfaces of less than about 0.161 mm;
coating at least a portion of one of the first and second major surfaces with a cross-linkable acrylic acid resin coating and a cross-linking agent; and
curing the cross-linkable acrylic acid resin coating and the cross-linking agent to form a cross-linked acrylic acid resin coating.

19. The method of claim 18, further including
adhering the second major surface of the retroreflective sheeting to a printable substrate.
